(19) United States
(12) Patent Application Publication
(10) Pub. No.: US 2008/0206704 A1
(43) Pub. Date: Aug. 28, 2008

(54) Dental modeling system with drillable tray base

(76) Inventor: Yunoh Jung, Murray, UT (US)

Correspondence Address: THORPE NORTH & WESTERN, LLP., P.O. Box 1219, SANDY, UT, 84091-1219, US

(21) Appl. No.: 12/072,120

(22) Filed: Feb. 22, 2008

Related U.S. Application Data
(60) Provisional application No. 60/891,452, filed on Feb. 23, 2007.

(51) Int. Cl. A61C 11/00

(52) U.S. Cl. 433/60

(57) ABSTRACT

A dental articulating system and method configured to duplicate at least a portion of a patient's mouth for use in producing a dental prosthesis securing an impression tray to a flexible and resilient material on a stabilizing plate of an alignment fixture. The position of the impression tray is adjusted on the flexible and resilient material. A tray base is detachably secured to a bottom of the alignment fixture. The tray base with the alignment fixture thereon is placed on a drilling fixture. A drill bit is aligned with a location of an impression corresponding to a prepped tooth of the impression tray. A hole is drilled in the tray base corresponding to the prepped tooth.

### PRIORITY CLAIM

Benefit is claimed of U.S. Provisional Patent Application No. 60/891,452, filed Feb. 23, 2007, which is herein incorporated by reference in its entirety for all purposes.

### BACKGROUND OF THE INVENTION

1. Field of the Invention

The present invention relates generally to dental modeling and articulating systems and methods.

2. Related Art

The production of a dental prosthesis requires the production of a working dental model that is a substantially exact duplication of the patient's mouth, and upon which the prosthesis can be fabricated. Such dental prostheses can include crowns, bridges, caps (substructure) for CAD/CAM production, inlays, onlays and other restorative dental works.

The dental model can be supported on a dental articulator by a tray base with pins extending from the tray base into the dental model. Such pins are often difficult to position in relation to the tooth or teeth being modeled for the prosthesis.

### SUMMARY OF THE INVENTION

It has been recognized that it would be advantageous to develop a dental modeling and articulating system and method that makes accurate, precise and fast dental models from which dental prosthesis elements, such as crowns, bridges, caps (substructure) for CAD/CAM production, inlays, onlays, and other restorative dental works, can be fabricated.

The present invention provides a method for creating a dental model including securing an impression tray to a flexible and resilient material on a stabilizing plate of an alignment fixture. The position of the impression tray can be adjusted on the flexible and resilient material. A tray base can be detachably secured to a bottom of the alignment fixture. The tray base with the alignment fixture thereon can be placed on a drilling fixture. A drill bit can be aligned with a location of an impression corresponding to a prepped tooth of the impression tray. A hole can be drilled in the tray base corresponding to the prepped tooth.

The present invention provides a method for creating a dental model including securing an impression tray to a flexible and resilient material on a stabilizing plate of an alignment fixture. A tray base can be secured to a hinge of the alignment fixture. The tray base can be pivoted about the hinge of the alignment fixture to move the tray base and the stabilizing plate into a substantially parallel and opposing relationship. The position of the impression tray can be adjusted on the flexible and resilient material so that an occlusal plane of an impression on the impression tray corresponds to the tray base. The tray base can be removed from the hinge and then placed on a bottom of the alignment fixture. The tray base with the alignment fixture thereon can be placed on a drilling fixture. The tray base with the alignment fixture thereon can be placed on a drilling fixture. A drill bit can be aligned with a location of an impression corresponding to a prepped tooth of the impression tray. A hole can be drilled in the tray base corresponding to the prepped tooth.

The present invention provides a method for creating a dental model including securing an impression tray to a flexible and resilient material on a stabilizing plate of an alignment fixture. A locator base can be detachably connected to the alignment fixture. The locator base can be pivoted about a hinge of the alignment fixture to move the locator base and the stabilizing plate into a substantially parallel and opposing relationship. The position of the impression tray can be adjusted on the flexible and resilient material so that an occlusal plane of an impression on the impression tray corresponds to the locator base by viewing the impression tray through at least a translucent portion of the locator base. A tray base can be detachably secured to a bottom of the alignment fixture. The tray base with the alignment fixture thereon can be placed on a drilling fixture. A drill bit can be aligned with a location of an impression corresponding to a prepped tooth of the impression tray. A hole can be drilled in the tray base corresponding to the prepped tooth.

Additional features and advantages of the invention will be apparent from the detailed description which follows, taken in conjunction with the accompanying drawings, which together illustrate, by way of example, features of the invention.

### BRIEF DESCRIPTION OF THE DRAWINGS

FIGS. 1a-1e are views of a tray base in accordance with an embodiment of the present invention;

FIGS. 2a-b are views of another tray base in accordance with an embodiment of the present invention;

FIGS. 2c-d are views of a snap plate connectable to the tray bases of FIG. 1a-1e or 2a-b in accordance with an embodiment of the present invention;

FIG. 2e is a view of the snap plate of FIGS. 2c-d with the tray base of FIGS. 2a-b;

FIGS. 3a-d are views of a locator base in accordance with an embodiment of the present invention;

FIGS. 4a-d are views of an adaptor plate for attachment to the tray base of FIGS. 1a-e in accordance with an embodiment of the present invention;

FIGS. 5a and 5b are views of an alignment fixture with the locator base of FIGS. 3a-d and an impression in accordance with an embodiment of the present invention;

FIGS. 6a and 6b are views of an alignment fixture with the tray base of FIGS. 1a-e and an impression in accordance with an embodiment of the present invention;

FIGS. 7 and 8 are views of a drilling fixture with the tray base of FIGS. 1a-e, the adaptor plate of FIGS. 4a-d, the alignment fixture of FIGS. 5a-b, the locator base of FIGS. 3a-d, and an impression in accordance with an embodiment of the present invention;

FIGS. 9a-f and 10a-b and 11 are views of a tapered drill and a tapered pin for use with a tray base and prepped model in accordance with the present invention;

FIG. 12 is a view of a tray base magnetically coupled to a dental articulator in accordance with an embodiment of the present invention;

FIG. 13 is a view of a tray base snap fit to a dental articulator in accordance with an embodiment of the present invention;

FIGS. 14a-f are views of a tray base and an adapter plate in accordance with another embodiment of the present invention; and

FIGS. 15a-b are cross sectional views of the tray base and adapter plate of FIGS. 14a-f, shown in a separated configuration in FIG. 15a and a joined configuration in FIG. 15b.

### DETAILED DESCRIPTION

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

As illustrated in the figures, a dental modeling and articulating system or device and method, in accordance with the present invention is shown for use in producing a dental model that is a substantial duplicate of a patient's mouth for use in the production of dental prostheses. Such dental prostheses can include crowns, bridges, caps (substructure) for CAD/CAM production, inlays, onlays, and other restorative works.

The dental modeling and articulating system and method can be configured to duplicate at least a portion of a patient's mouth for use in producing a dental prosthesis. One or more impressions of a patient's teeth can be made to make opposing models of the patient's teeth, including a prepped model including a prepped tooth to receive a dental prosthesis, and an opposing model of an opposite tooth opposite the prepped tooth. The opposing models can include a prosthesis model of the patient's teeth to receive the prosthesis, and an opposing model of the teeth opposite the prosthesis model.

Thus, the dental modeling and articulating system and method can include tray bases, such as a working tray base and an opposing tray base. The working tray base can hold a cast or model that requires dental prosthesis work. The opposing tray base can hold a model of a patient's teeth that opposes the prosthesis work. The working tray base and the opposing tray base can be pivotally coupled together, such as with a dental articulator. Additionally, the working tray base can have a working die receiving surface, and the opposing tray base can have an opposing die receiving surface.

The die receiving surfaces of the tray bases can receive dental casting material, and dies or models of a patient's teeth. For example, the working tray base and working die receiving surface can receive a prepped model or prosthesis die of one or more prepped teeth of a patient. The prepped model can include a model of a prepped tooth, or a prosthesis die, to receive a dental prosthesis. Thus, the working tray base and working die receiving surface can receive the prepped model of the tooth that will be worked on. The opposing tray base and opposing die receiving surface can receive an opposing model or cast of one or more opposing teeth of a patient that oppose the prepped teeth in the prepped model. The opposing model can include a model of an opposite tooth opposite the prepped tooth.

It will be appreciated that the working tray base can receive a prepped model that can correspond to either the patient's upper or lower teeth. The working tray base can be positioned as the lower tray for convenience. Similarly, the opposing tray base can receive the opposing model and can be oriented as the upper tray. It will further be appreciated that the working tray base and opposing tray base can have different configurations than shown or can have similar or the same configurations. Because a majority of dental cases (about 97%) require prosthetics or the like for only the upper or lower side of the mouth, it is typically only necessary to have one working tray base. However, in cases where both the upper and lower side of the mouth require prosthetics or the like, then two working tray bases can be used.

The tray bases can pivot with respect to one another between open and closed configurations, such as with a dental articulator, as is known in the art. In the closed configuration, the tray bases and models generally face one another in an opposing, spaced-apart, and parallel relationship. In the open configuration, the tray bases and models can pivot away from one another. The closed configuration corresponds to, or models, or imitates a patient's closed mouth, and positions the dies or models of the patient's teeth against one another. The open configuration allows the dies or models of the patient's teeth to be separated for producing dental prosthesis and the like. In addition, the tray bases can be detachably connected to one another or the dental articulator.

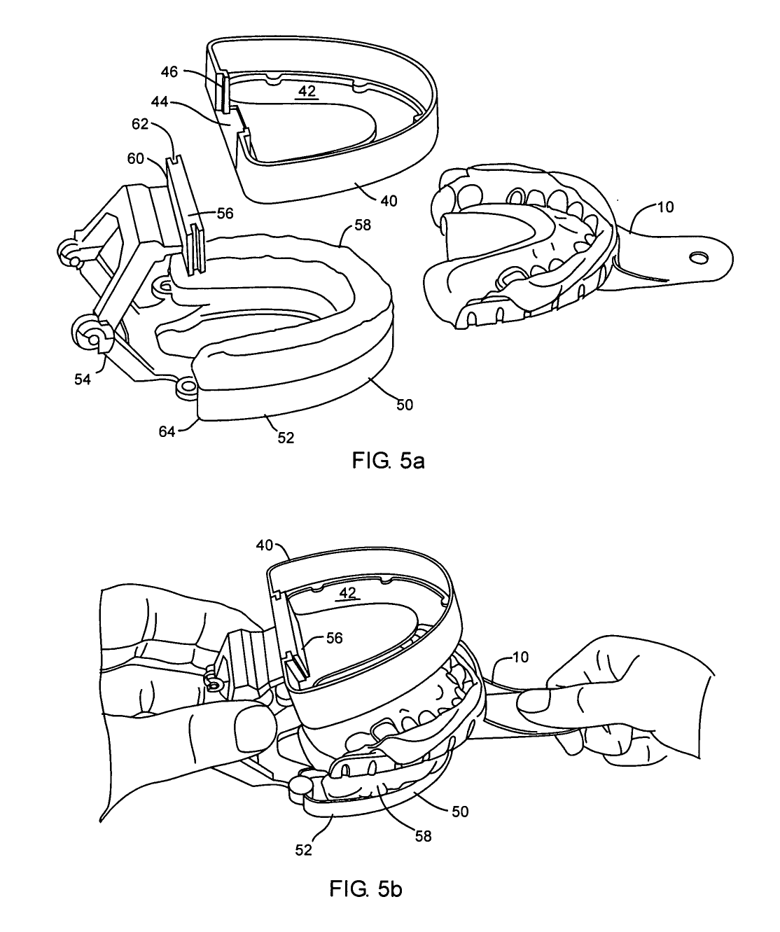

Forming the prepped model and opposing model can include obtaining a double bite side impression or a single bite side impression 10 (as shown in FIGS. 5a-8 and 10b-11) of at least some of a patient's teeth. The impression can typically be made by a dentist by placing a formable material onto a tray or the like, and having the patient bite into the formable material, thus leaving a negative impression or cavity 180 of the patient's teeth, as is known in the art. The negative impression or cavity 180 can be used as a mold to form a hardened cast model of the patient's teeth. The impression can include a prepped side with an impression of the prepped tooth 184 to receive a dental prosthesis, and an opposing side with an impression of the opposite tooth opposing the prepped tooth. Such an impression can typically be provided to the technician.

The impression can be disposed adjacent the tray base. Dental casting material can be introduced between the tray base and the impression to form the prepped model 20. The prepped model can be segmented on sides corresponding to the prepped tooth 24 to form the prosthesis die. In practice, a dental technician can cut the cast to separate out and form the master or prosthesis die to be worked on. The cast can be cut into segments so that each segment has at least one registration pin (or no pins at all if preferred). Segments can be removed and reinserted into their precise location on the tray base to reproduce the model of the original impression.

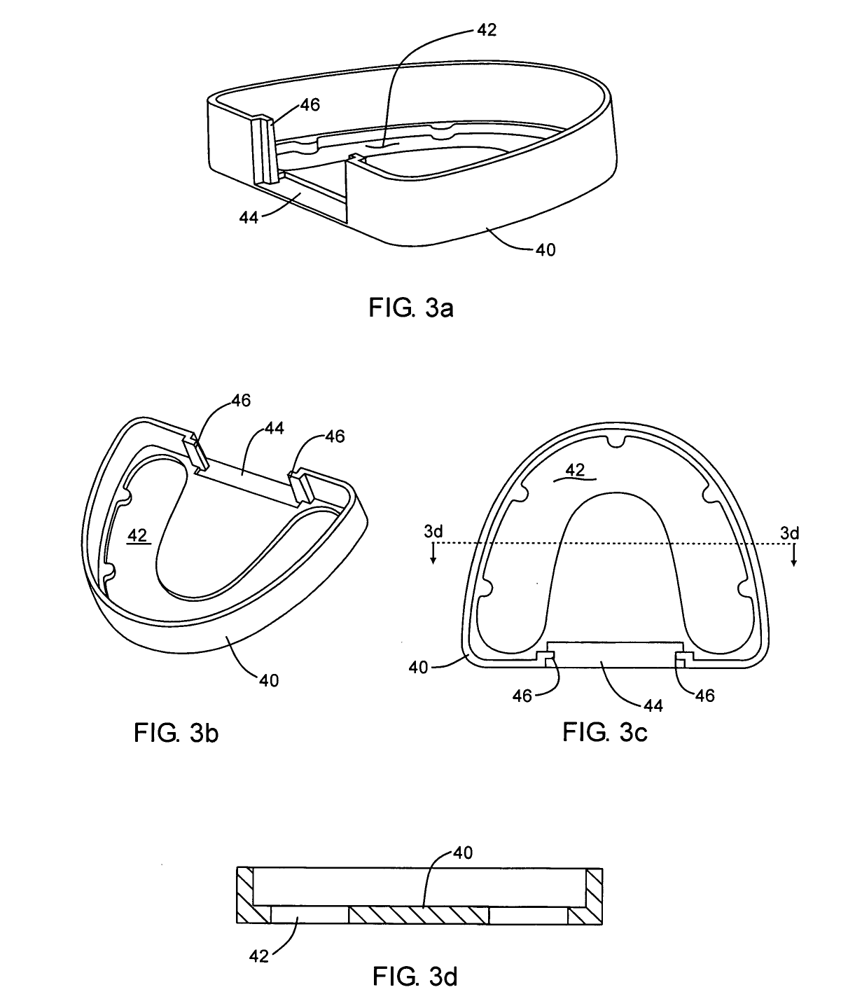

In accordance with one aspect of the present invention, referring to FIGS. 5a, 5b, 7 and 8, a method for creating a dental model includes detachably connecting a locator base 40 to an alignment fixture 50. Referring to FIGS. 3a-3d, the locator base 40 has at least a translucent portion or transparent portion, such as an aperture 42, defining a window in which the impression tray 10 can be viewed. The locator base 40 can be formed of plastic with an aperture or window formed of a translucent or transparent plastic. The locator base 40 can be shaped similarly to a tray base, as described below, and thus can have a solid U-shape generally corresponding to the shape of a patients teeth or mouth.

Referring to FIGS. 5a-5b, the alignment fixture 50 can include a stabilizing plate 52, a connector hinge 54, and a connector 56. The stabilizing plate 52 can have an upper surface that is sufficiently large enough to balance and support a single side bite impression 10 or a double side bite impression throughout the process of making a prepped model. The surface of the stabilizing plate 52 can receive a flexible, resilient and tacky material such as dental putty 58 for the purpose of separably connecting the impression 10 to the stabilizing plate 52.

The connector hinge 54 can include at least one set of hinges that can allow pivotal movement of the stabilizing plate 52 in relation to the locator base 40 (or tray base), which can be attached to the connector 56 of the aligning fixture 50 opposite the stabilizing plate 52. Pivotal movement between the stabilizing plate 52 and the locator base 40 (or tray base) provides a method of efficiently checking and, if necessary, correcting the position of the impression 10 on the dental putty 58. The at least one set of hinges extend outwardly in opposing directions. In one direction the hinge extends and is attached to the stabilizing plate and in the other direction the other hinge extends and is removably attached to the connector 56.

The connector 56 is one means by which the locator base 40 (or tray base) can be separably connected to the aligning fixture 50, thereby allowing separable connection to the impression 10. The connector 56 can include a tab 60 to fit into a notch 44 of the locator base 40 (or tray base) and can have slots 62 to receive tabs 46 of the locator base 40 (or tray base).

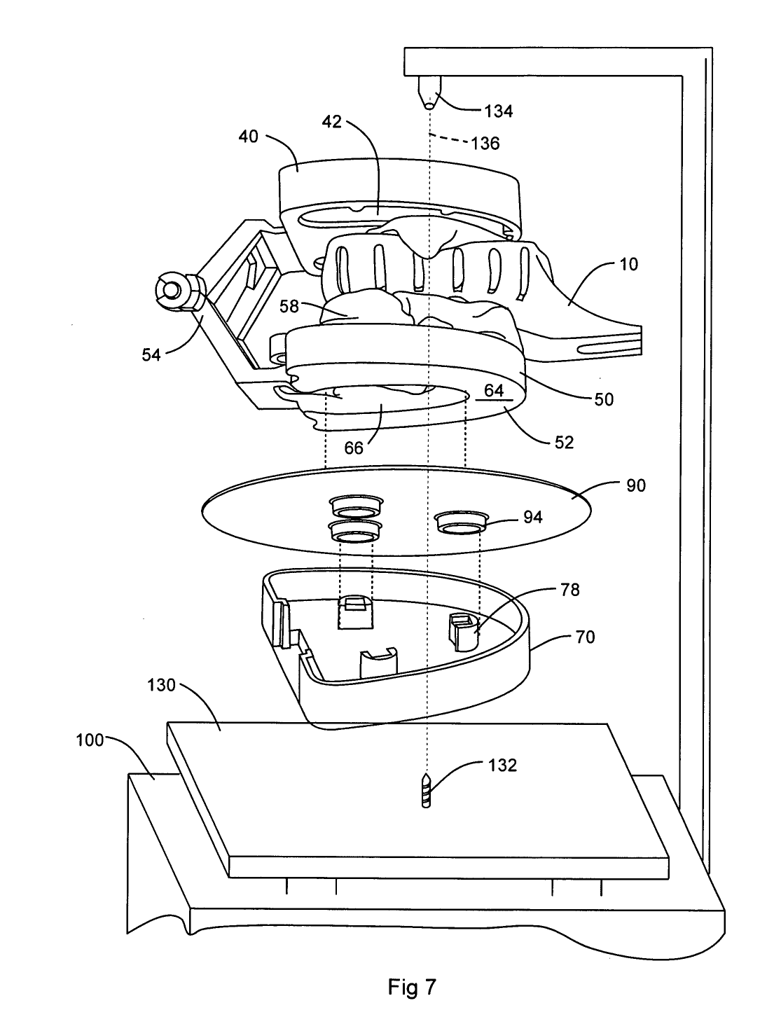

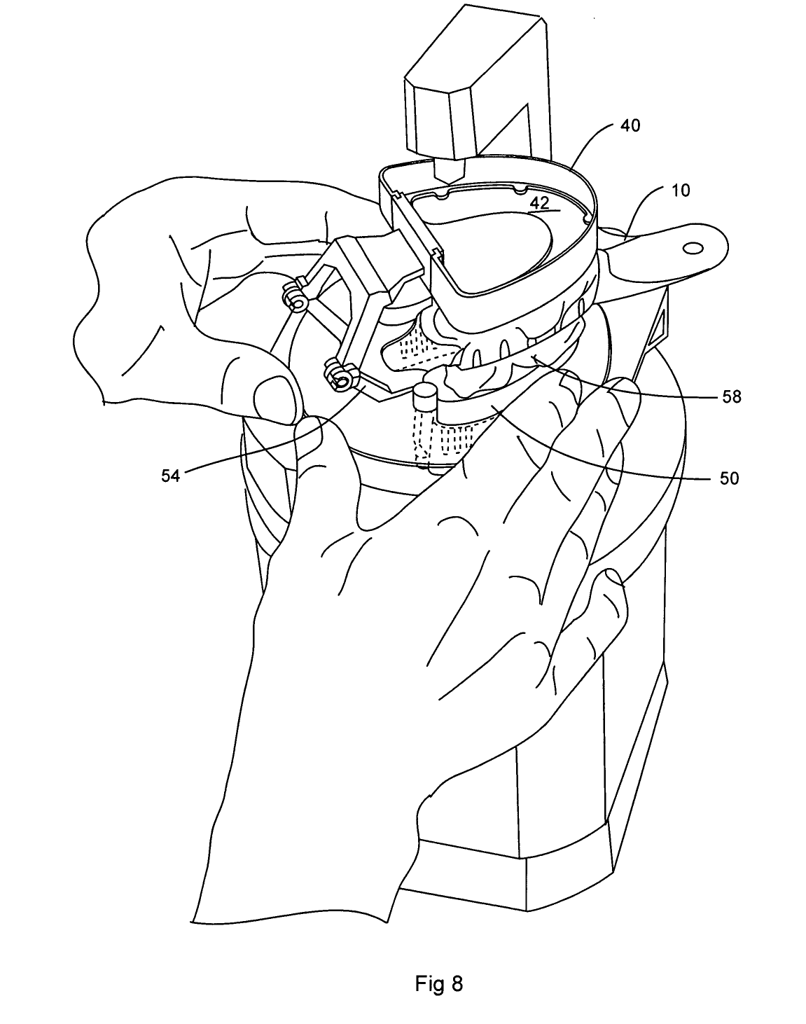

In addition, the bottom of the alignment fixture 50 or stabilizing plate. 52 can have an aperture 66 (FIG. 7), such as a generally U-shaped aperture, the purpose of which is described below.

Various aspects of such a hinge are described in U.S. Pat. No. 6,948,932, which is herein incorporated by reference.

Referring again to FIGS. 5a, 5b, 7 and 8, the impression tray 10 is secured to a flexible and resilient material 58 on the alignment fixture 52. The locator base 40 is pivoted about a hinge 54 of the alignment fixture 52 to move the locator base and the stabilizing plate 52 into a substantially parallel and opposing relationship. The position of the impression tray 10 is adjusted on the flexible and resilient material 58 so that an occlusal plane of an impression on the impression tray 10 corresponds to the locator base 40 by viewing the impression tray through at least a translucent portion 42 of the locator base.

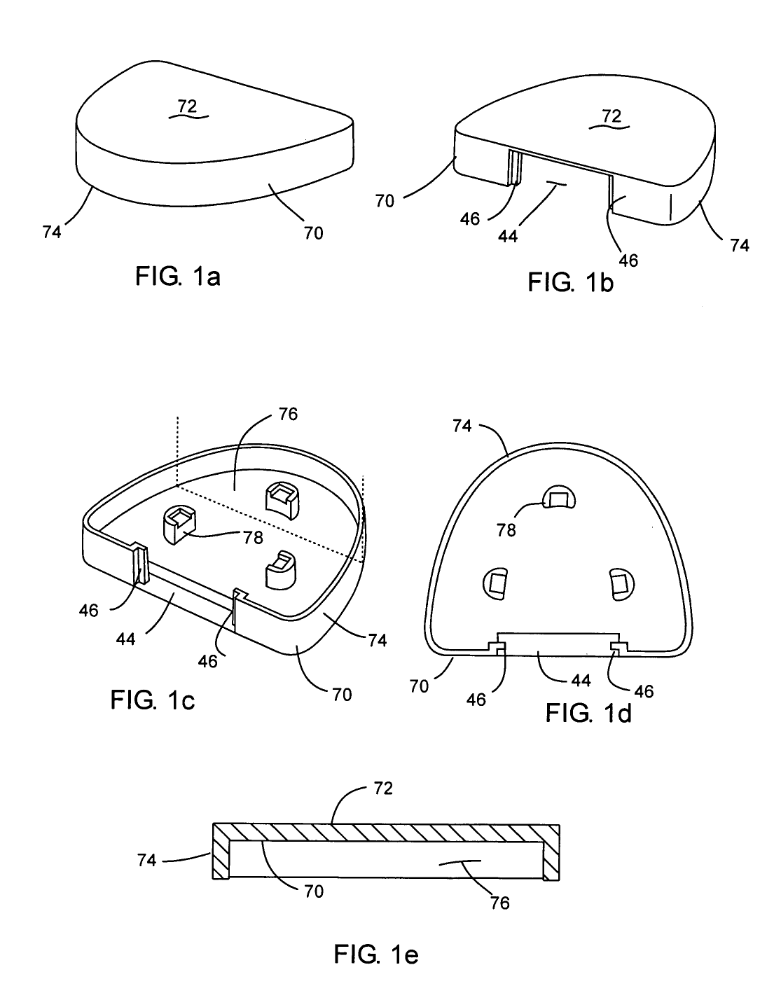

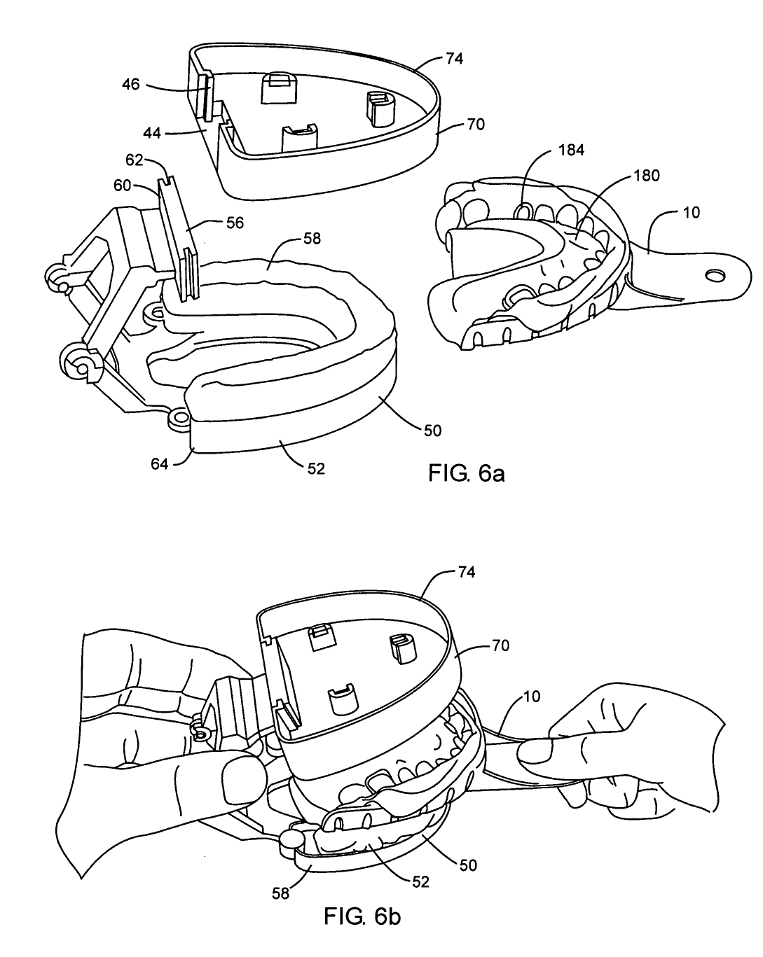

A tray base 70, 80, or 470 is removably secured to a bottom 64 of the alignment fixture 50, as shown in FIGS. 7 and 8. As described above, the tray base 70 can receive the prepped model 20. In one aspect, as shown in FIGS. 1a-e, the tray base 70 can have a substantially flat upper surface 72 to receive the prepped model 20 (FIG. 1). The upper surface 72 can have a perimeter shape with a straight side and curved side, generally corresponding to a patient's teeth or mouth. A perimeter wall 74 can extend from the flat upper surface to form a pocket 76 (FIG. 1c) under the flat upper surface. As described above, a notch 44 can be formed in the perimeter wall 74 at the back side to mate with a connection 56 of an alignment fixture (as shown in FIGS. 6a and 6b), the purpose of which will be described below.

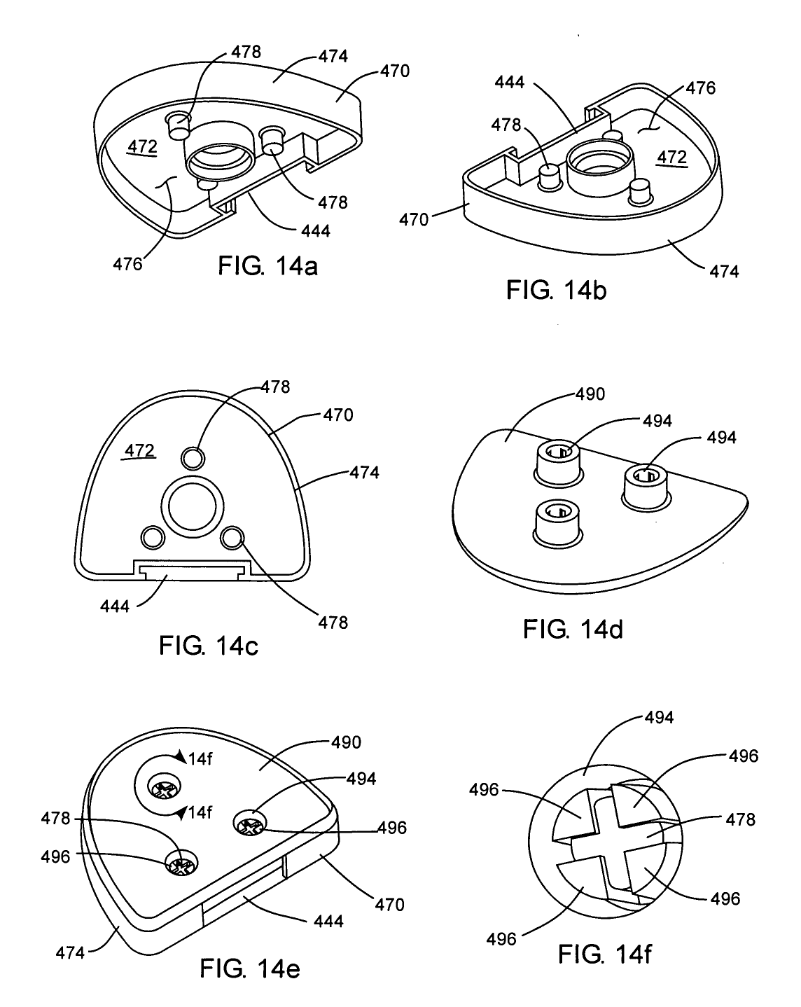

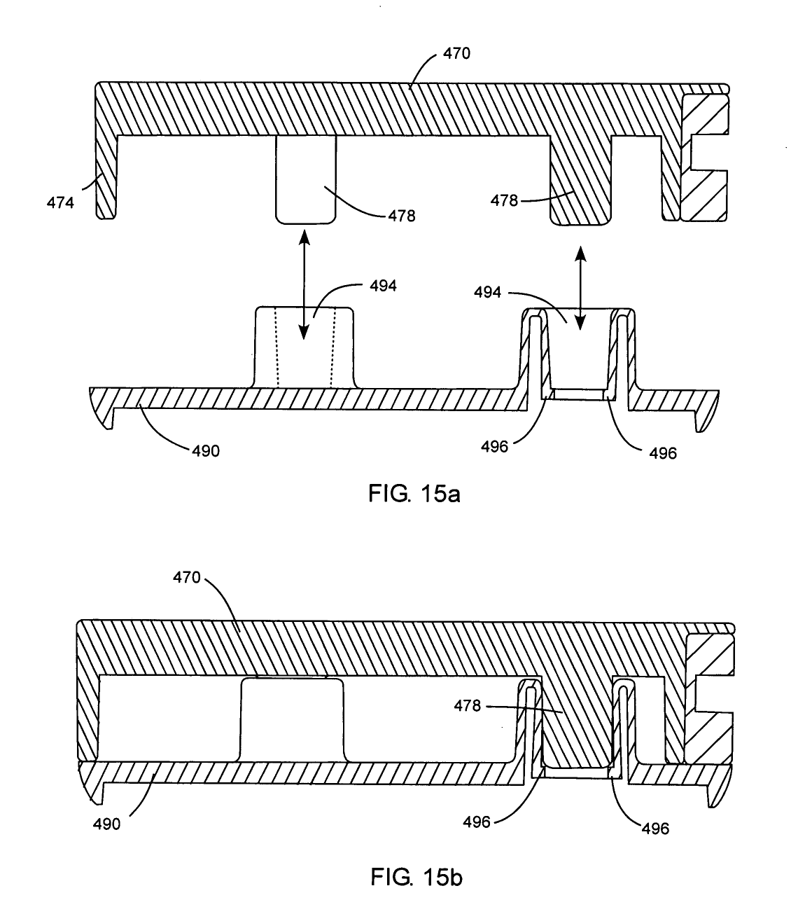

In another aspect, as shown in FIGS. 14a-c, the tray base 470 can have a substantially flat upper surface 472 to receive the prepped model 20 (FIG. 1). The upper surface 472 can have a perimeter shape with a straight side and curved side, generally corresponding to a patient's teeth or mouth. A perimeter wall 474 can extend from the flat upper surface to form a pocket 476 (FIG. 1c) under the flat upper surface. A notch 444 can be formed in the perimeter wall 474 at the back side to mate with a connection 56 of an alignment fixture (as shown in FIGS. 6a and 6b), the purpose of which will be described below.

In addition, the tray bases 70 and 470 can have a plurality of attachment portions, such as three posts 78 and 478, respectively, configured to attach to other structure, such as an adaptor plate as described below.

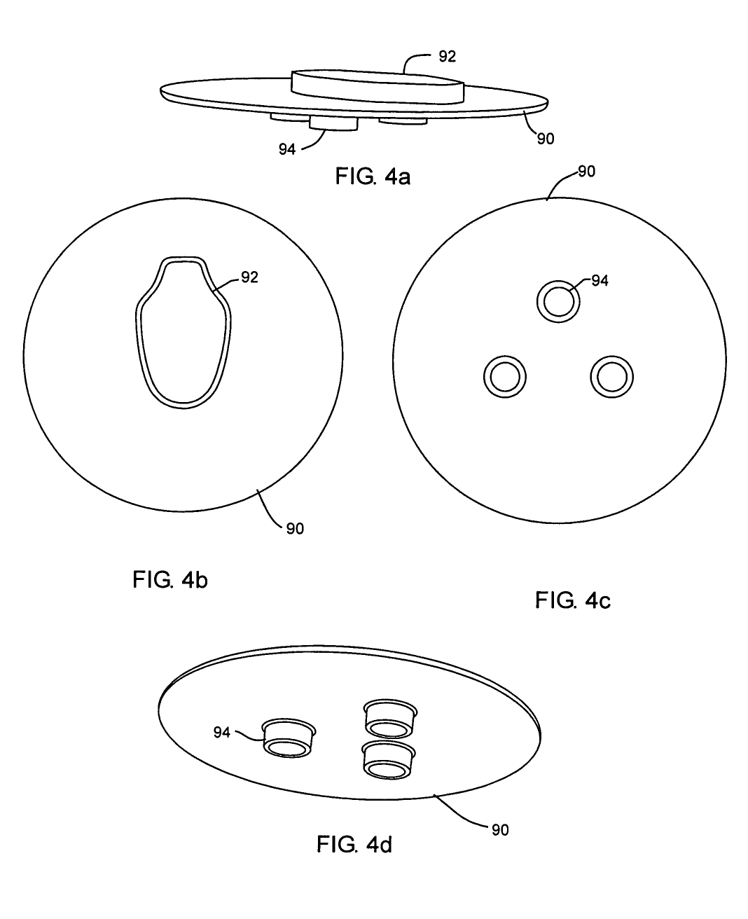

Referring again to FIGS. 5a, 5b, 7 and 8, the tray base 70 can be detachably secured to the bottom of the alignment fixture 50. One means for attaching the tray base to the bottom of the alignment fixture includes an adapter plate 90 removably attached between the tray base 70 and the alignment fixture 50. In one aspect, as shown in FIGS. 4a-d, the adaptor plate 90 can have a protrusion 92, such as a U-shaped wall, that can mate with the aperture 66 of the alignment fixture 50. In addition, the adaptor plate 90 can have holes 94 or posts with holes corresponding to the posts 78 of the tray base 70 to attach the adaptor plate to the tray base. Alternatively, the adaptor plate can have a U-shaped protrusion extenable into the U-shaped opening of the tray base to attach the adaptor plate to the tray base.

In another aspect, as shown in FIGS. 14d-e and 15a-b, the adaptor plate 490 can have a protrusion (not shown), such as a U-shaped wall, that can mate with the aperture 66 of the alignment fixture 50. In addition, the adaptor plate 490 can have holes 494 corresponding to the posts 478 of the tray base 470 to attach the adaptor plate to the tray base. The holes 494 can have split walls 496 that can be biased to a position smaller than the posts 478. The split walls 496 can separate to a position that allows the posts 478 to fit tightly within the hole. In this way, the split walls 496 can help secure the tray base 470 to the adapter plate 490.

Returning to FIGS. 5a, 5b, 7 and 8, the tray base 70 coupled to the bottom of the alignment fixture 72, and impression tray 10 disposed thereon can be placed on a drilling fixture 100. As is known in the art, the drilling fixture 100 can have a table 130 onto which the tray base can be placed with a drill bit 132 disposed underneath the table 130. The drill bit 132 can move vertically up and down to drill pin holes in the tray base 70.

In addition, a laser guide 134 may be disposed over the table 130 and directs a laser light, indicated by dashed lines at 136, aligned with the drill bit 132, onto the impression tray 10 (and through the locator base 40 or window thereof). Thus, with the tray base 70 and impression tray 10 aligned and held in place by the alignment fixture 50 and adaptor plate 90, the laser light 136 can be aligned where desired on the impression tray 10, and a corresponding hole drilled in the tray base 70.

The drilling fixture 100 can be a standard fixture. The drill bit 132 can be aligned, such as with a location of an impression corresponding to the prepped tooth of the impression tray, and a hole 102 drilled in the tray base corresponding to the prepped tooth. It will be appreciated that numerous holes can be drilled as desired to hold the prepped model. As described in greater detail below, the drill bit 132 can be tapered to drill a tapered hole to receive a tapered portion of a pin 104.

A pin 104 can be inserted into the hole 102 on the tray base 70. Dental casting material can be applied between the tray base and the impression tray and allowed to cure, forming a prepped model 20, as is known in the art. See FIGS. 10a-11. The prepped model of the prepped tooth can be formed over the pin 104 on the tray base 70. For example, the dental casting material 182 (FIG. 10b) can be poured over the pin 104. The dental casting material can be disposed in the tray base 70 and the impression by pouring the dental casting material while it is in a semi-liquid, uncured state. After the dental casting material substantially hardens, cures, dries, and/or solidifies, the impression can be removed. An opposing model can eventually be formed to use in conjunction with the prepped model.

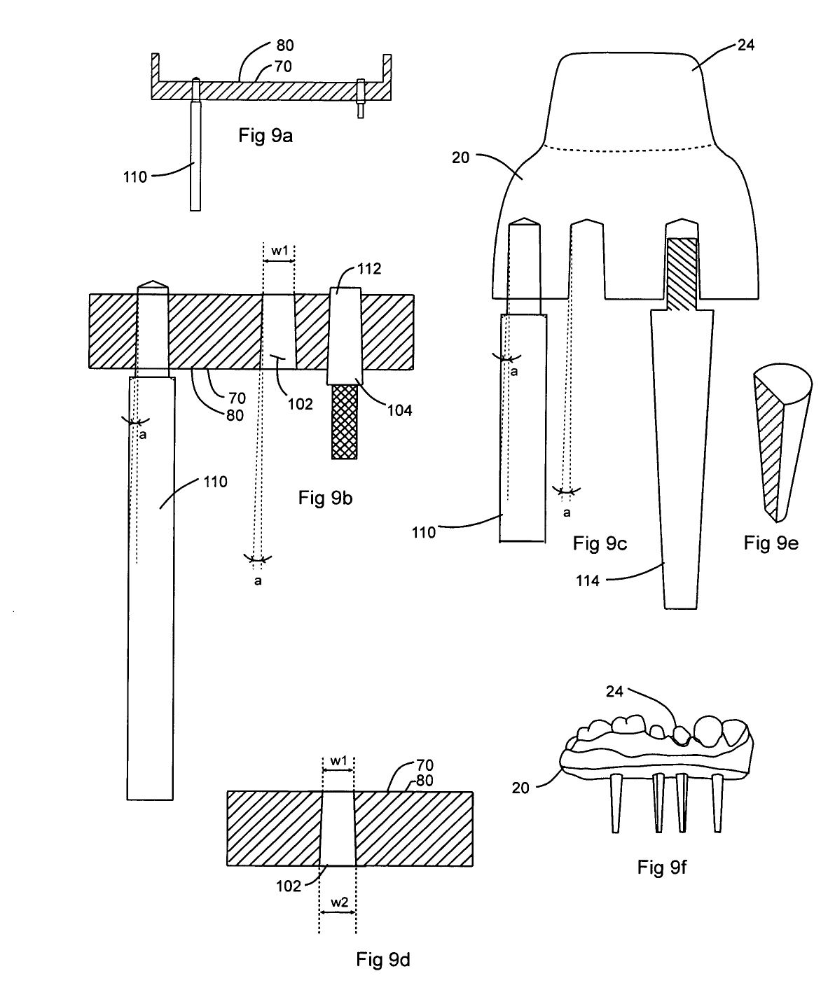

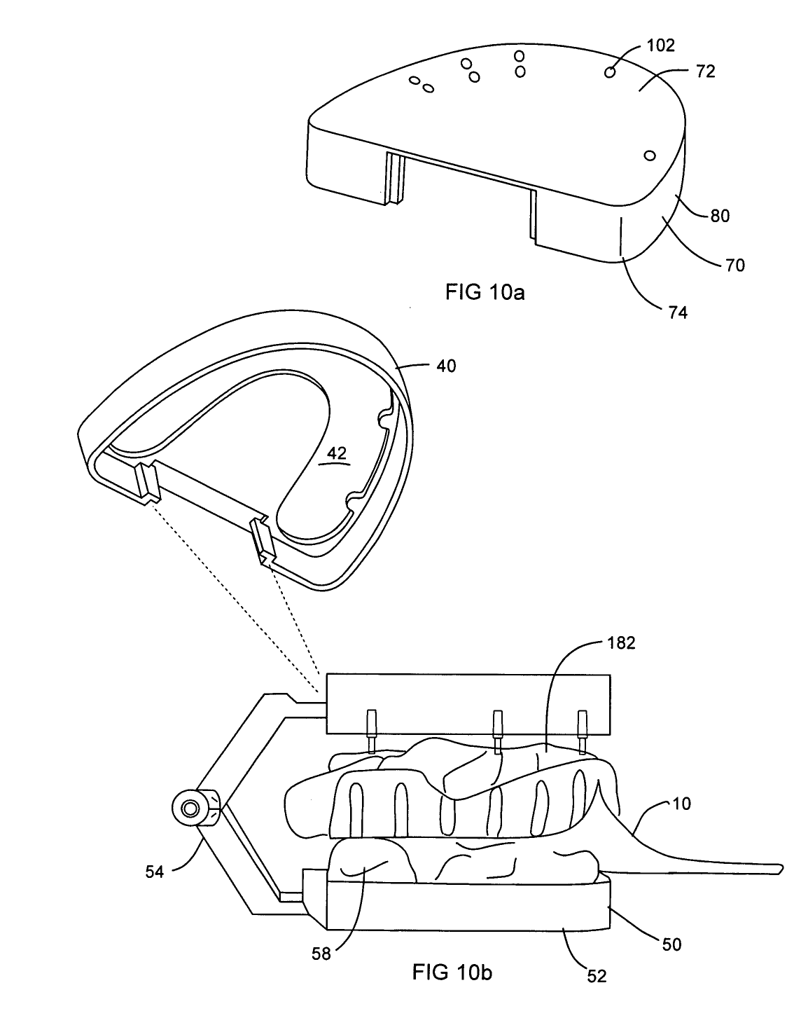

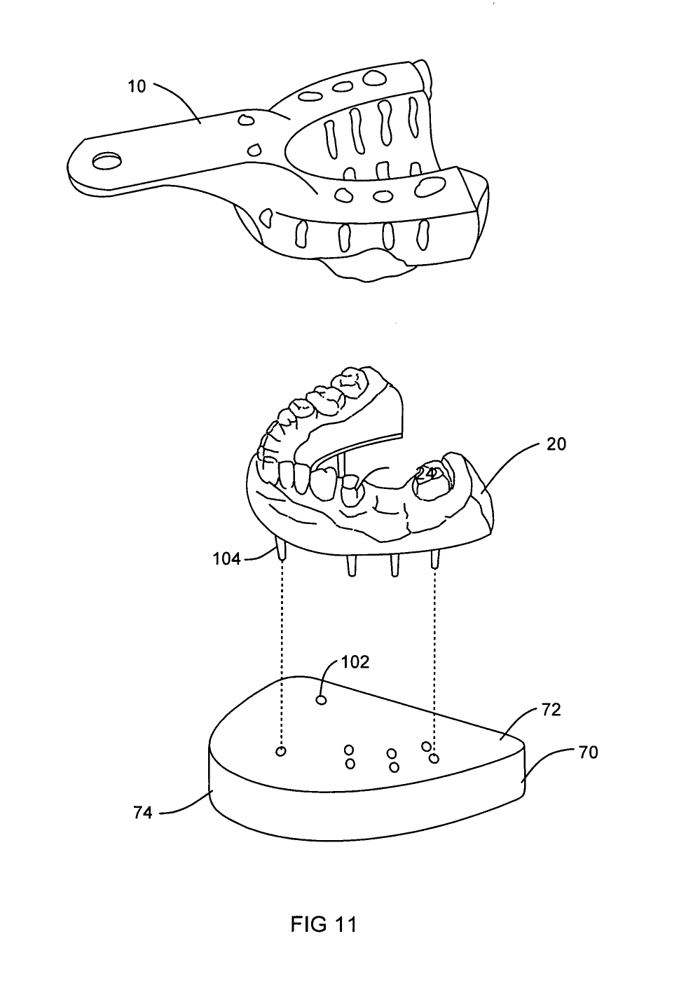

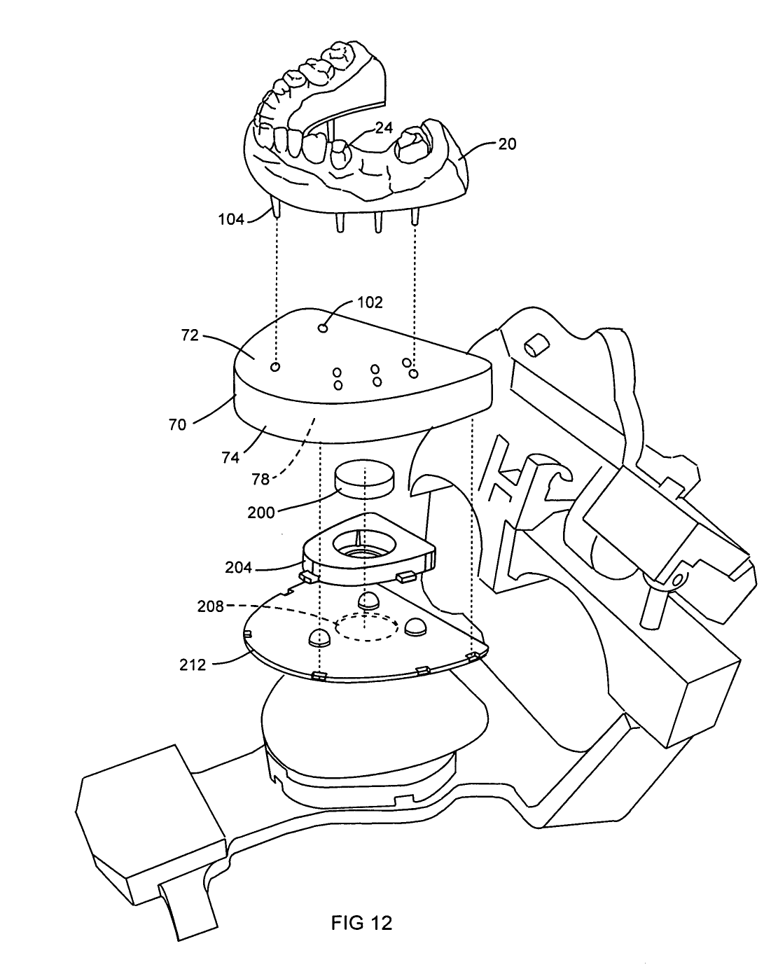

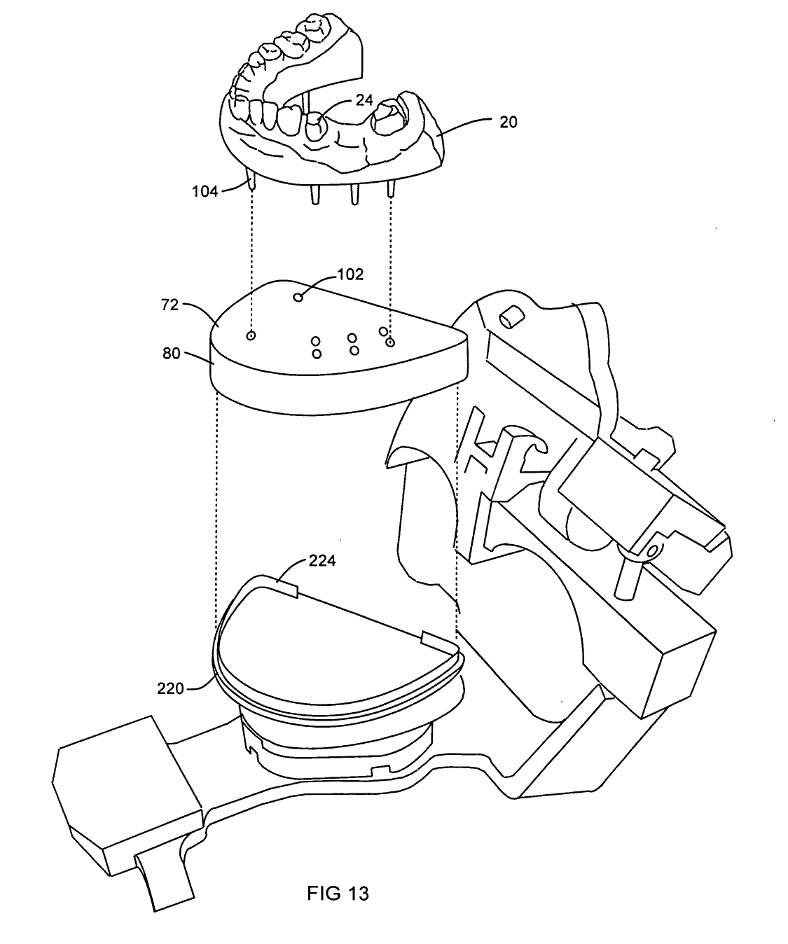

As indicated above, the drilling fixture 100 can be a standard drilling fixture. Referring to FIGS. 9a-9f, however, the standard straight drill bit can be removed and replaced with a tapered drill bit 110 to form the tapered holes 102. The pins 202 can have a tapered portion 112 (FIG. 9b) that mates with the tapered holes 102. The taper on the bit and the holes can be slight so that standard pins 114 can be utilized with the tapered holes, as shown in FIG. 9c. The registration pin holes and the registration pins can be slightly tapered to help seat and secure the pins in the holes so that there is substantially no play or movement between the pin and the hole.

Referring to FIG. 12, the tray base 70 with the prepped model 20 thereon can be attached to a dental articulator (dental articulators are known in the art). The attachment can be magnetic, as shown. A magnet 200 can be attached to the tray base 70, such as with a magnet holder 204. The magnet holder 204 can be carried by the posts 78 of the tray base, such as by tabs of the magnet holder snap fitting or interference fitting with slots in the posts. A ferrous material or disc 208 can be attached to the dental articulator by securing a plate 212 carrying the ferrous material to the dental articulator with dental plaster. It will be appreciated that the position of the magnet and the ferrous disc can be reversed, with the ferrous disc on the tray base and the magnet on the plate or articulator.

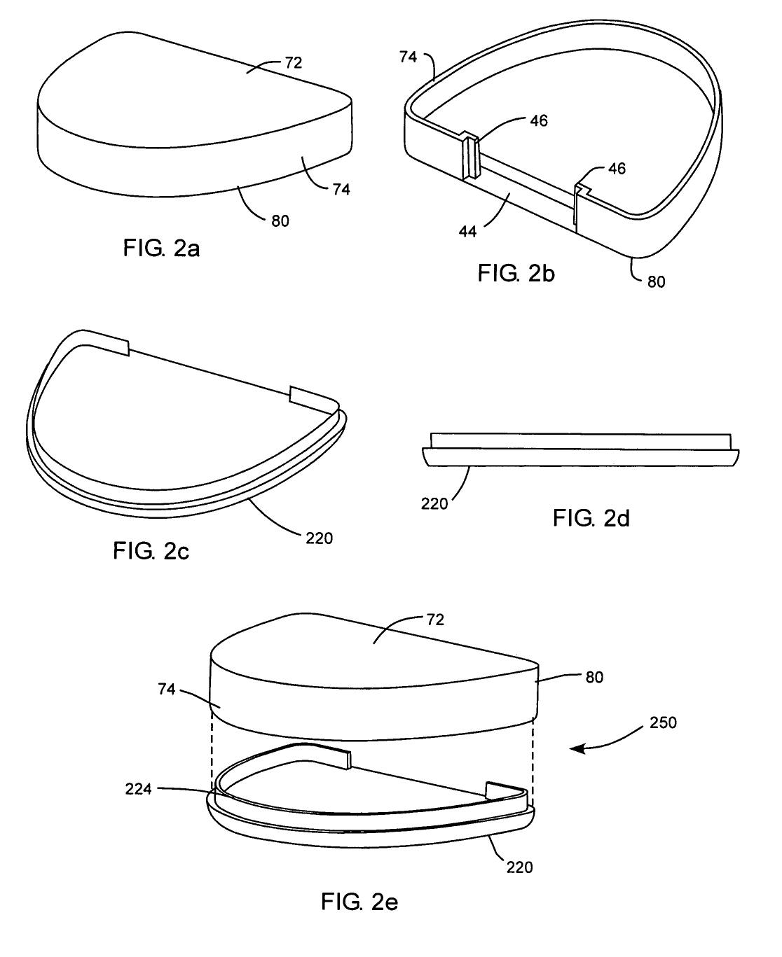

Alternatively, the tray base 80 can be attached to the dental articulator with a snap plate 220. Referring to FIGS. 2c-2e, the snap plate 220 can be shaped similarly to the tray base 80, and can have a perimeter wall 224 shaped to mate with the perimeter wall 74 of the tray base 80, such as by snap fit or interference fit. (The snap plate 220 can also be used with tray base 70.) Referring to FIG. 13, the snap plate 220 can be secured to the dental articulator with dental plaster. It will be appreciated that the position of the wall and hole can be reversed.

It will be appreciated that an opposing model can be formed and securing the opposing model to the dental articulator, as is known in the art.

In accordance with another aspect of the present invention, a method of creating a dental model can be performed as above, but without the use of the locator base 40, and instead using a tray base 70 or 80. For example, the tray base 70 or 80 can be formed of translucent or transparent plastic, enabling the technician to see through the tray base to the impression plate. Referring to FIGS. 6a and 6b, a tray base 70 or 80 can be detachably connected to an alignment fixture 52, similar to that described above with respect to the locator base 40. An impression tray 70 or 80 can be secured to a flexible and resilient material on the alignment fixture. The tray base can be pivoted about a hinge 54 of the alignment fixture 52 to move the tray base and the stabilizing plate into a substantially parallel and opposing relationship. The position of the impression tray can be adjusted on the flexible and resilient material so that an occlusal plane of an impression on the impression tray corresponds to the tray base. The tray base can be removed from the alignment fixture, and detachably secured to a bottom of the alignment fixture. Other steps, as described above, can be performed.

In accordance with another aspect of the present invention, a method of creating a dental model can be performed as above, but without the use of a locator base or tray base. The method can include: securing an impression tray to a flexible and resilient material on an alignment fixture having a hinge; adjusting the position of the impression tray on the flexible and resilient material; detachably securing a tray base to a bottom of the alignment fixture; the tray base configured to receive the dental model; placing the tray base with the alignment fixture thereon on a drilling fixture; aligning a tapered drill bit with a location of an impression corresponding to the prepped tooth of the impression tray; drilling a tapered hole in the tray base corresponding to the prepped tooth; and inserting a tapered portion of a pin into the tapered hole. Other steps, as described above, can be performed.

In accordance with another aspect of the present invention, a tray base device 70 configured to receive a prepped model of a patient's mouth for use in producing a dental prosthesis includes a substantially flat upper surface 72 configured to receive the prepped model and having a perimeter shape with a straight side and curved side; a perimeter wall 74 extending from the flat upper surface to form a pocket 76 under the flat upper surface; and a plurality of attachment portions, such as posts 78, configured to attached to other structure. A notch 44 formed in the perimeter wall 74 at the back side configured to mate with a connection 56 of an alignment fixture 50 having a hinge 54 and a stabilizing plate 52 with dental putty thereon to secure an impression to the stabilizing plate.

In accordance with another aspect of the present invention, a dental articulating system 250 (FIG. 2e) configured to duplicate at least a portion of a patient's mouth for use in producing a dental prosthesis includes a tray base 80 and a snap plate 220. The tray base includes: a substantially flat upper surface configured to receive the prepped model and having a perimeter shape with a straight side and curved side; and a perimeter wall extending from the flat upper surface to form a pocket under the flat upper surface. The snap plate is removably attachable to a bottom of the tray base, and includes: a bottom surface configured to attach to a dental articulator; and a perimeter nesting inside the perimeter wall of the tray base. A notch 44 can be formed in the perimeter wall of the tray base at the back side to mate with a connection of an alignment fixture having a hinge and a stabilizing plate a dental putty thereon to secure an impression to the stabilizing plate.

In accordance with another aspect of the present invention, a dental articulating system configured to duplicate at least a portion of a patient's mouth for use in producing a dental prosthesis includes a tray base and an alignment fixture. The tray base receives a prepped model and includes a substantially flat upper surface configured to receive the prepped model and has a perimeter shape with a straight side and curved side. A perimeter wall extends from the flat upper surface to form a pocket under the flat upper surface. The alignment fixture includes: a stabilizing plate to receive a dental putty thereon to secure an impression to the stabilizing plate; a hinge coupled to an end of the stabilizing plate; the hinge being operable to pivot the tray base and stabilizing plate with respect to one another; and means for removably coupling the tray base to the hinge. In addition, the tray base is removably securable to a bottom of the alignment fixture. An adaptor plate can be disposable between the alignment fixture and the tray base.

It will be appreciated that the above described system and method can be used to make models without Various aspects of dental articulators and dental modeling systems can be found in U.S. Pat. Nos. 6,948,932 and 7,147,465; and U.S. Provisional Patent Application Ser. Nos. 60/393,160 and 60/454,216; and U.S. patent application Ser. Nos. 11/361,835 and 11/361,853; which are herein incorporated by reference.

It is to be understood that the above-referenced arrangements are only illustrative of the application for the principles of the present invention. Numerous modifications and alternative arrangements can be devised without departing from the spirit and scope of the present invention. While the present invention has been shown in the drawings and fully described above with particularity and detail in connection with what is presently deemed to be the most practical and preferred embodiments(s) of the invention, it will be apparent to those of ordinary skill in the art that numerous modifications can be made without departing from the principles and concepts of the invention as set forth in the claims.

What is claimed is:

1. A method of creating a dental model, comprising;
a) securing an impression tray to a flexible and resilient material on a stabilizing plate of an alignment fixture;
b) adjusting the position of the impression tray on the flexible and resilient material;
c) detachably securing a tray base to a bottom of the alignment fixture;
d) placing the tray base with the alignment fixture thereon on a drilling fixture;
e) aligning a drill bit with a location of an impression corresponding to a prepped tooth of the impression tray; and
f) drilling a hole in the tray base corresponding to the prepped tooth.

2. A method in accordance with claim 1, further comprising:
a) initially removably securing the tray base to a hinge of the alignment fixture;
b) pivoting the tray base about the hinge of the alignment fixture to move the tray base and the stabilizing plate into a substantially parallel and opposing relationship;
c) wherein adjusting the position of the impression tray further includes adjusting the position of the impression tray so that an occlusal plane of an impression on the impression tray corresponds to the tray base; and
d) removing the tray base from the hinge prior to placing the tray base on the bottom of the alignment fixture.

3. A method in accordance with claim 1, further comprising:
a) detachably connecting a locator base to the alignment fixture;
b) wherein adjusting the position of the impression tray further includes adjusting the position of the impression tray so that an occlusal plane of an impression on the impression tray corresponds to the locator base by viewing the impression tray through at least a translucent portion of the locator base; and
c) replacing the locator base with the tray base after drilling the holes.

4. A method in accordance with claim 1, wherein detachably securing the tray base to the bottom of the alignment fixture further includes:
removably attaching an adapter plate between the bottom of the alignment fixture and the tray base.

5. A method in accordance with claim 1, wherein drilling the hole includes drilling the hole with a tapered bit to create a tapered hole; and further comprising inserting a tapered portion of a pin into the tapered hole.

6. A method in accordance with claim 1, further comprising:
a) removing the tray base from the bottom of the alignment fixture and securing the tray base to a hinge of the alignment fixture;
b) inserting a pin into the hole on the tray base;
c) pivoting the tray base about the hinge of the alignment fixture to move the tray base and the stabilizing plate into a substantially parallel and opposing relationship; and
d) applying dental casting material between the tray base and the impression tray and allowing the dental casting material to cure forming a prepped model.

7. A method in accordance with claim 6, further comprising:
a) securing the tray base with the prepped model to a dental articulator.

8. A method in accordance with claim 7, further comprising:
a) forming an opposing model and securing the opposing model to the dental articulator.

9. A method of creating a dental model, comprising;
a) securing an impression tray to a flexible and resilient material on a stabilizing plate of an alignment fixture;
b) securing a tray base to a hinge of the alignment fixture;
c) pivoting the tray base about the hinge of the alignment fixture to move the tray base and the stabilizing plate into a substantially parallel and opposing relationship;
d) adjusting the position of the impression tray on the flexible and resilient material so that an occlusal plane of an impression on the impression tray corresponds to the tray base;
e) removing the tray base from the hinge and then placing the tray base on a bottom of the alignment fixture;
f) placing the tray base with the alignment fixture thereon on a drilling fixture;
g) aligning a drill bit with a location of an impression corresponding to a prepped tooth of the impression tray; and
h) drilling a hole in the tray base corresponding to the prepped tooth.

10. A method in accordance with claim 9, wherein the tray base is at least translucent such that the impression tray can be visibly detectable through the tray base when the tray base and the stabilizing plate are positioned in the substantially parallel and opposing relationship.

11. A method in accordance with claim 9, wherein detachably securing the tray base to the bottom of the alignment fixture further includes;
removably attaching an adapter plate between the bottom of the alignment fixture and the tray base.

12. A method in accordance with claim 9, further comprising:
a) removing the tray base from the bottom of the alignment fixture and securing the tray base to a hinge of the alignment fixture;
b) inserting a pin into the hole on the tray base;
c) pivoting the tray base about the hinge of the alignment fixture to move the tray base and the stabilizing plate into a substantially parallel and opposing relationship; and
d) applying dental casting material between the tray base and the impression tray and allowing the dental casting material to cure forming a prepped model.

13. A method in accordance with claim 12, further comprising:
a) securing the tray base with the prepped model to a dental articulator.

14. A method in accordance with claim 13, further comprising:
a) forming an opposing model and securing the opposing model to the dental articulator.

15. A method of creating a dental model, comprising;
a) securing an impression tray to a flexible and resilient material on a stabilizing plate of an alignment fixture;
b) detachably connecting a locator base to the alignment fixture;
c) pivoting the locator base about a hinge of the alignment fixture to move the locator base and the stabilizing plate into a substantially parallel and opposing relationship;
d) adjusting the position of the impression tray on the flexible and resilient material so that an occlusal plane of an impression on the impression tray corresponds to the locator base by viewing the impression tray through at least a translucent portion of the locator base;
e) detachably securing a tray base on a bottom of the alignment fixture;
f) placing the tray base with the alignment fixture thereon on a drilling fixture;
g) aligning a drill bit with a location of an impression corresponding to a prepped tooth of the impression tray; and
h) drilling a hole in the tray base corresponding to the prepped tooth.

16. A method in accordance with claim 15, wherein detachably securing the tray base to the bottom of the alignment fixture further includes;
removably attaching an adapter plate between the bottom of the alignment fixture and the tray base.

17. A method in accordance with claim 15, further comprising:
a) removing the locator base from the hinge of the alignment fixture;
b) removing the tray base from the bottom of the alignment fixture;
c) securing the tray base to the hinge of the alignment fixture;
b) inserting a pin into the hole on the tray base;
c) pivoting the tray base about the hinge of the alignment fixture to move the tray base and the stabilizing plate into a substantially parallel and opposing relationship; and
d) applying dental casting material between the tray base and the impression tray and allowing the dental casting material to cure forming a prepped model.

18. A method in accordance with claim 17, further comprising:
a) securing the tray base with the prepped model to a dental articulator.

19. A method in accordance with claim 18, further comprising:
a) forming an opposing model and securing the opposing model to the dental articulator.

20. A tray base device configured to receive a prepped model of a patient's mouth for use in producing a dental prosthesis, the device comprising:
a substantially flat upper surface configured to receive the prepped model and having a perimeter shape with a straight side and curved side;
a perimeter wall extending from the flat upper surface to form a pocket under the flat upper surface; and
a plurality of attachment portions opposite the flat upper surface configured to attached to other structure.

21. A device in accordance with claim 20, wherein the straight side defines a back of the device, and further comprising:
a notch formed in the perimeter wall at the back side configured to mate with a connection of an alignment fixture having a hinge and a stabilizing plate with dental putty thereon to secure an impression to the stabilizing plate.
